(19) United States
(12) Patent Application Publication
(10) Pub. No.: US 2025/0201881 A1
(43) Pub. Date: Jun. 19, 2025

(54) FUEL CELL SYSTEM AND CONTROL METHOD OF FUEL CELL SYSTEM

(71) Applicants: KABUSHIKI KAISHA TOSHIBA, Tokyo (JP); TOSHIBA ENERGY SYSTEMS & SOLUTIONS CORPORATION, Kawasaki-shi Kanagawa (JP)

(72) Inventors: Hikaru TAKAMATA, Shinagawa Tokyo (JP); Kyohei YAMASHITA, Yokohama Kanagawa (JP)

(73) Assignees: KABUSHIKI KAISHA TOSHIBA, Tokyo (JP); TOSHIBA ENERGY SYSTEMS & SOLUTIONS CORPORATION, Kawasaki-shi Kanagawa (JP)

(21) Appl. No.: 18/988,400

(22) Filed: Dec. 19, 2024

(30) Foreign Application Priority Data
Dec. 19, 2023 (JP) 2023-214026

(51) Int. Cl. H01M 8/04746; H01M 8/04119; H01M 8/0438

(52) U.S. Cl. CPC H01M 8/04761; H01M 8/04156; H01M 8/0438

(57) ABSTRACT

According to one embodiment, a fuel cell system includes: a fuel cell stack; a storage part that stores a water component including circulating water supplied to the fuel cell stack, and generated water generated in and discharged from the fuel cell stack; a gas outlet pipe that sends a gas discharged from the fuel cell stack to the storage part; a pressure acquisition part that acquires a pressure of the gas discharged from the fuel cell stack; a drain pipe connected to the storage part to allow the water component discharged from the storage part to flow therethrough; a drain valve on the drain pipe; and a control device. The control device controls opening and closing of the drain valve based on a pressure of a gas acquired by the pressure acquisition part.

### CROSS REFERENCE TO RELATED APPLICATIONS

This application is based upon and claims the benefit of priority from the prior Japanese Patent Application No. 2023-214026 filed on Dec. 19, 2023, the entire contents of which are incorporated herein by reference.

### FIELD

Embodiments described herein relate generally to a fuel cell system and a control method of a fuel cell system.

### BACKGROUND

A solid polymer electrolyte fuel cell with a solid polymer electrolyte membrane generally is required to humidify a supplied gas in order for sufficient power generation performance. At the same time, it is also generally required to be cooled in order to remove heat generated by battery reaction. One known method of simultaneously carrying out humidification and cooling is the internal humidification and cooling method, which uses an electrically conductive porous plate with micropores as a separator. This method can prevent leakage of fuel gas and oxidant gas by controlling a difference between a pressure of the fuel gas and the oxidant gas, and a pressure of cooling and humidification water within a certain range while filling the micropores of the conductive porous plate with water. This allows for uniform humidification and cooling within a reaction surface to be carried out simultaneously. Further, since water generated by the battery reaction (generated water) is recovered via the conducive porous plate by increasing the pressure of the fuel gas and the oxidant gas compared with the pressure of the cooling and humidification water, performance degradation due to flooding can be prevented.

A known method for controlling a differential pressure between the pressure of the fuel gas and the oxidant gas, and the pressure of the cooling and humidification water within a certain range is to connect a pipe for a gas to be discharged from a fuel cell stack to a cooling and humidification water tank to keep constant the differential pressure between the gases and the cooling and humidification water.

As described above, when the pipe for a gas to be discharged from the fuel cell stack is connected to the cooling and humidification water tank, some of the water generated by the battery reaction is usually condensed and thereafter recovered in the aforementioned cooling and humidification water tank. Then, such generated water increases gradually. Thus, this structure usually controls a drain valve to periodically discharge water stored in the cooling and humidification tank together with the generated water to the outside of the system, in order to prevent water clogging in the pipe. A known method for determining a timing of such drainage is to provide the tank with a water level gauge to monitor an amount of generated water and to discharge the water in response to the detection of the water level gauge. Another known method is to predict an amount of generated water based on a cumulative amount of generated electricity and to discharge the water in response to a predicted value.

However, the above discharging technology may not necessarily function as desired depending on conditions of application of the fuel cell system. For example, when the fuel cell system is mounted on a mobile vehicle such as a car or a truck the above discharging technology may not necessarily function well.

Specifically, when the fuel cell system is mounted on a mobile vehicle, a water level in a tank varies because of inclination and acceleration/deceleration. This can make it difficult to accurately monitor the water level. In addition, when an amount of generated water is predicted based on a cumulative amount of generated electricity, it is required to accurately calculate a ratio of a component of the generated water, which is condensed and recovered, and a ratio of a component of the generated water, which is discharged as water vapor along with exhaust gas, for example. This requires measurement by many sensors and correction. However, in a situation where surrounding conditions and generated electricity output vary each and every second as in the mobile vehicle, reliability of a predicted value may lower. In the case of false detection of an amount of generated water inside the system, the drain pipe may be released to the atmosphere at an unexpected timing. Such unnecessary drainage may lose pressure balance in the fuel cell system. This results in impairment of power generation capacity and product life, and even in inoperable condition.

### BRIEF DESCRIPTION OF THE DRAWINGS

FIG. 1 is a view schematically showing a fuel cell system according to a first embodiment.

FIG. 2 is a schematic cross-sectional view of a fuel cell stack of the fuel cell system according to the first embodiment.

FIG. 3 is a view explaining a relationship between a pressure of a gas discharged from the fuel cell stack shown in FIG. 2 and a timing of draining a water component stored in a storage part of the fuel cell system.

FIG. 4 is a flowchart explaining an operation of the fuel cell system according to the first embodiment.

FIG. 5 is a view schematically showing a fuel cell system according to a second embodiment.

FIG. 6 is a view explaining a relationship between a duty cycle of a drive pulse signal for a gas back pressure regulation valve and a timing of draining a water component stored in a storage part in the fuel cell system according to the second embodiment.

FIG. 7 is a flowchart explaining an operation of the fuel cell system according to the second embodiment.

### DETAILED DESCRIPTION

A fuel cell system according to one embodiment includes: a fuel cell stack; a storage part that stores a water component including circulating water supplied to the fuel cell stack and circulated from the fuel cell stack, and generated water generated in the fuel cell stack and discharged from the fuel cell stack; a gas outlet pipe that sends a gas discharged from the fuel cell stack to the storage part; a pressure acquisition part that acquires a pressure of the gas discharged from the fuel cell stack; a drain pipe connected to the storage part to allow the water component discharged from the storage part to flow therethrough; a drain valve on the drain pipe; and a control device that controls opening and closing of the drain valve. The control device controls the opening and closing of the drain valve based on a pressure of the gas acquired by the pressure acquisition part.

A fuel cell system according to one embodiment includes: a fuel cell stack; a storage part that stores a water component including circulating water supplied to the fuel cell stack and circulated from the fuel cell stack, and generated water generated in the fuel cell stack and discharged from the fuel cell stack; a gas outlet pipe that sends a gas discharged from the fuel cell stack to the storage part; a pressure acquisition part that acquires a pressure of the gas discharged from the fuel cell stack; a gas back pressure regulation valve that regulates a pressure of the gas to be sent to the storage part, based on a drive pulse signal whose duty cycle is varied based on a pressure of the gas acquired by the pressure acquisition part; a duty cycle acquisition part that acquires a duty cycle of the drive pulse signal for the gas back pressure regulation valve; a drain pipe connected to the storage part to allow the water component discharged from the storage part to flow therethrough; a drain valve on the drain pipe; and a control device that controls opening and closing of the drain valve. The control device controls the opening and closing of the drain valve based on a duty cycle of the drive pulse signal acquired by the duty cycle acquisition part

A control method of a fuel cell system according to one embodiment is a control method of a fuel cell system including: a fuel cell stack; a storage part that stores a water component including circulating water supplied to the fuel cell stack and circulated from the fuel cell stack, and generated water generated in the fuel cell stack and discharged from the fuel cell stack; a gas outlet pipe that sends a gas discharged from the fuel cell stack to the storage part; a drain pipe connected to the storage part to allow the water component discharged from the storage part to flow therethrough; and a drain valve on the drain pipe. The method includes: acquiring a pressure of the gas discharged from the fuel cell stack; and controlling opening and closing of the drain valve based on an acquired pressure of the gas.

A control method of a fuel cell system according to one embodiment is a control method of a fuel cell system including: a fuel cell stack; a storage part that stores a water component including circulating water supplied to the fuel cell stack and circulated from the fuel cell stack, and generated water generated in the fuel cell stack and discharged from the fuel cell stack; a gas outlet pipe that sends a gas discharged from the fuel cell stack to the storage part; a pressure acquisition part that acquires a pressure of the gas discharged from the fuel cell stack; a gas back pressure regulation valve that regulates a pressure of the gas to be sent to the storage part, based on a drive pulse signal whose duty cycle is varied based on a pressure of the gas acquired by the pressure acquisition part; a drain pipe connected to the storage part to allow the water component discharged from the storage part to flow therethrough; and a drain valve on the drain pipe. The method includes: acquiring a duty cycle of the drive pulse signal for the gas back pressure regulation valve; and controlling opening and closing of the drain valve based on an acquired duty cycle of the drive pulse signal.

Respective embodiments are described hereunder with respect to the attached drawings.

### First Embodiment

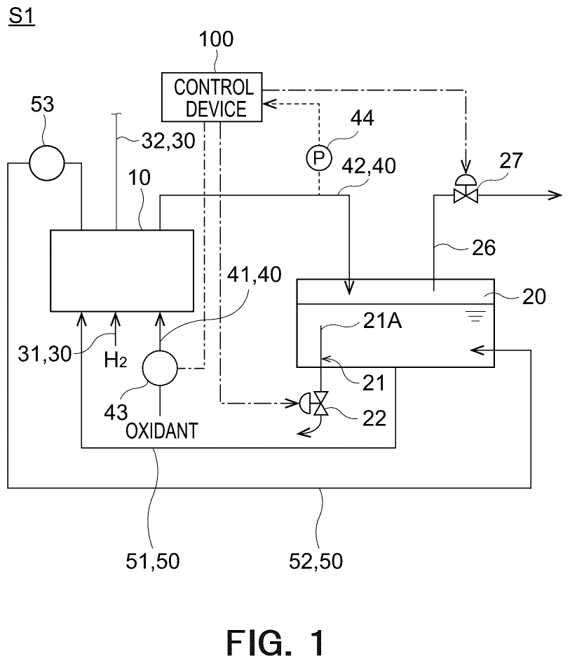

FIG. 1 schematically shows a fuel cell system S1 according to a first embodiment. As shown in FIG. 1, the fuel cell system S1 includes a fuel cell stack 10, a storage part 20, a fuel gas pipe 30, an oxidant gas pipe 40, a circulating water pipe 50, and a control device 100.

The fuel cell stack 10 is supplied with a fuel gas through the fuel gas pipe 30, and is supplied with an oxidant gas through the oxidant gas pipe 40. Then, the fuel cell stack 10 develops a battery reaction to generate electricity. The storage part 20 stores circulating water described later for humidifying the fuel cell stack 10 and cooling heat generated by the battery reaction. The circulating water pipe 50 sends the circulating water from the storage part 20 to the fuel cell stack 10 to circulate the circulating water from the fuel cell stack 10 to the storage part 20. The control device 100 controls the respective parts of the fuel cell system S1. The respective parts of the fuel cell system S1 are described in detail hereunder.

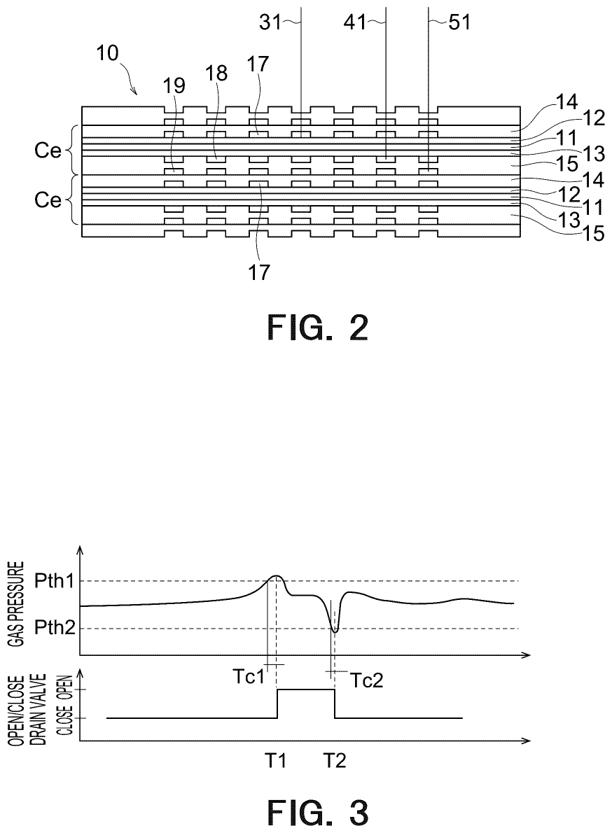

As described above, the fuel cell stack 10 reacts hydrogen (H2) contained in the fuel gas, which has been supplied thereto through the fuel gas pipe 30 as described above, with an anode electrode 12, and reacts oxygen contained in the oxidant gas, which has been supplied thereto through the oxidant gas pipe 40, with a cathode electrode 13. FIG. 2 is a schematic cross-sectional view of the fuel cell stack 10.

As shown in FIG. 2, the fuel cell stack 10 is made by stacking a plurality of unit cells Ce. The unit cell Ce includes a diaphragm 11, the anode electrode 12, the cathode electrode 13, an anode separator 14, and a cathode separator 15.

The fuel cell stack 10 in this embodiment is of a solid polymer electrolyte type. Thus, the diaphragm 11 is a solid polymer electrolyte membrane (ion exchange membrane) having ion conductivity. The anode electrode 12 is arranged in contact with one surface of the diaphragm 11, and the cathode electrode 13 is arranged in contact with the other surface of the diaphragm 11. A stacked body of the diaphragm 11, the anode electrode 12 and the cathode electrode 13 is sometimes referred to as membrane electrode assembly hereunder.

The anode separator 14 and the cathode separator 15 are arranged to sandwich therebetween the membrane electrode assembly (11, 12, 13). The anode separator 14 is arranged in contact with the anode electrode 12, and the cathode separator 15 is arranged in contact with the cathode electrode 13. In this embodiment, the anode separator 14 and the cathode separator 15 are formed of a porous body made of an electrically conductive metal, carbon or ceramics. The anode separator 14 and the cathode separator 15 are plate-shaped.

The aforementioned unit cells Ce are stacked such that the anode separator 14 of one of the two adjacent unit cells Ce is in contact with the cathode separator 15 of the other.

The fuel cell stack 10 is provided with a fuel gas path 17, which at least partly faces the anode electrode 12 to allow the aforementioned fuel gas to flow therethrough to be supplied to the anode electrode 12, an oxidant gas path 18, which at least partly faces the cathode electrode 13 to allow the aforementioned oxidant gas to flow therethrough to be supplied to the cathode electrode 13, and a circulating water path 19, which allows the circulating water from the storage part 20 to flow therethrough.

In detail, a plurality of the fuel gas paths 17 are formed in the anode separator 14. The fuel gas path 17 is in the form of a groove, for example, and is formed in a surface of the anode separator 14, which faces the anode electrode 12. A plurality of the oxidant gas paths 18 and a plurality of the circulating water paths 19 are formed in the cathode separator 15.

The oxidant gas paths 18 is in the form of a groove, for example, and is formed in a surface of the cathode separator 15, which faces the cathode electrode 13. The circulating water path 19 is in the form of a groove, for example, and is formed in a surface of the cathode separator 15, which is opposite to the surface in which the oxidant gas paths 18 are formed. The oxidant gas paths 18 and the circulating water paths 19 are spaced from each other in a thickness direction of the cathode separator 15.

The circulating water paths 19 may be formed in the anode separator 14 instead of the cathode separator 15. Alternatively, a separator with the circulating water paths 19 formed therein may be provided in addition to the anode separator 14 and the cathode separator 15, and this separator may be provided between the anode separator 14 and the cathode separator 15.

Returning to FIG. 1, the fuel gas pipe 30 has a fuel gas inlet pipe 31 and a fuel gas outlet pipe 32 which are respectively connected to the fuel cell stack 10. The fuel cell stack 10 takes in the fuel gas containing hydrogen from the fuel gas inlet pipe 31, and reacts the hydrogen with the anode electrode 12. The fuel cell stack 10 discharges unreacted fuel gas to the fuel gas outlet pipe 32.

The fuel gas may be stored in a tank, for example. In this case, an upstream end of the fuel gas inlet pipe 31 may be connected to the tank storing the fuel gas. The fuel gas discharged from the fuel cell stack 10 to the fuel gas outlet pipe 32 may be discharged to the atmosphere, for example.

The oxidant gas pipe 40 has an oxidant gas inlet pipe 41 and an oxidant gas outlet pipe 42 which are respectively connected to the fuel cell stack 10. The fuel cell stack 10 takes in the oxidant gas containing oxygen from the oxidant gas inlet pipe 41, and reacts the oxygen with the cathode electrode 13. The fuel cell stack 10 discharges unreacted fuel gas to the oxidant gas outlet pipe 42.

The oxidant gas inlet pipe 41 is provided with a compressor 43. The compressor 43 compresses the oxidant gas and supplies it to the fuel cell stack 10. This can increase an amount of oxygen to be supplied to the fuel cell stack 10 per unit time, as compared to a case in which the oxidant gas is not compressed, to thereby increase power generation output. The oxidant gas may be air in the atmosphere. In this case, an upstream end of the oxidant gas inlet pipe 41 may be open to the atmosphere. When the oxidant gas inlet pipe 41 is open to the atmosphere, air serving as the oxidant gas flows into the oxidant gas inlet pipe 41 in accordance with the drive of the compressor 43. The compressor 43 is electrically connected to the control device 100 so that its driving state (discharge pressure, rotation speed) is controlled by the control device 100.

The oxidant gas outlet pipe 42 connects the fuel cell stack 10 and the storage part 20. The oxidant gas outlet pipe 42 sends the oxidant gas discharged from the fuel cell stack 10 to the storage part 20.

The storage part 20 is a container for storing a water component including the circulating water supplied to the fuel cell stack 10 and circulated from the fuel cell stack 10, and generated water generated in the fuel cell stack 10 and discharged from the fuel cell stack 10. The circulating water is previously stored in the storage part 20 before the operation, in order to cool and humidify the fuel cell stack 10. When the generated water is stored in the storage part 20, the generated water can cool and humidify the fuel cell stack 10 together with the circulating water.

A drain pipe 21 and a gas discharge pipe 26 are connected to the storage part 20. The drain pipe 21 is provided with a drain valve 22. The drain pipe 21 allows the water component discharged from the storage part 20 to flow therethrough. Opening and closing of the drain valve 22 allows and blocks passage of the water component through the drain pipe 21. Increase in amount of the generated water stored in the storage part 20 increases a pressure in the storage part, which may impair operation stability. The drain pipe 21 and the drain valve 22 are provided to avoid such a situation.

The drain pipe 21 in this embodiment is provided such that an intake port 21A thereof, which is an upstream end, is positioned above a bottom surface of the storage part 20. In this case, when the intake port 21A is below a water level in the storage part 20, the drain valve 22 is opened to start a draining operation. When the water level in the storage part 20 lowers down to the position of the intake port 21A, the draining operation is mechanically stopped. This avoids excessive discharge of the water component. In this embodiment, after the water level in the storage part 20 has lowered down to the position of the intake port 21A, the drain valve 22 is closed, so that draining is completely blocked. As described below, in a case where the intake port 21A is positioned above the bottom surface of the storage part 20, the oxidant gas flowing into the storage part 20 from the oxidant gas outlet pipe 42 is allowed to flow into the intake port 21A when the water level in the storage part 20 lowers down to the position of the intake port 21A. In this embodiment, since the water component can be discharged through the intake port 21A positioned above the bottom surface of the storage part 20, the pressure in the storage part 20 can be relatively largely dropped off during the draining. Then, the drain valve 22 can be closed based on the relatively largely dropped off pressure. This makes it possible to detect an appropriate timing of closing the drain valve 22 based on a pressure, while avoiding excessive discharge of the water component.

In addition, the above-described mechanism for mechanically stopping the draining operation utilizing the position of the intake port 21A is simpler than a mechanism for closing the drain valve 22 using a water level gauge. Moreover, as compared with a case in which the draining operation is stopped by closing the drain valve 22, load on the drain valve 22 can be reduced. However, the intake port 21A of the drain pipe 21 may be connected to the bottom of the storage part 20.

The drain valve 22 is electrically connected to the control device 100 so that its opening and closing operation is controlled by the control device 100. The drain valve 22 in this embodiment is an on-off valve by which two positions, i.e., an opening state and a closing state are switched. Switching between the open and close of the drain valve 22 may be performed either by an electromagnetic solenoid or by supply/shutoff of air.

The gas discharge pipe 26 receives the oxidant gas having flown from the fuel cell stack 10 to the storage part 20, and allows it to flow therethrough for discharge. The gas discharge pipe 26 is connected to an upper part of the storage part 20, in this example, an upper surface thereof. In detail, the gas discharge pipe 26 is connected to the storage part 20 at a position above the intake port 21A of the drain pipe 21. The gas discharge pipe 26 is provided with a gas back pressure regulation valve 27. With its opening degree being regulated, the gas back pressure regulation valve 27 regulates an amount of the oxidant gas flowing through the gas discharge pipe 26. This regulates a pressure of a gas phase of the storage part 20, a pressure in the oxidant gas outlet pipe 42, and a pressure in the fuel cell stack 10. As a result, the gas back pressure regulation valve 27 regulates a pressure of the oxidant gas which is discharged from the fuel cell stack 10 and is sent to the storage part 20.

Increase in pressure in the storage part 20 may impair operation stability. The gas discharge pipe 26 and the gas back pressure regulation valve 27 are provided in order to avoid such a situation. The gas back pressure regulation valve 27 is electrically connected to the control device 100 so that its opening and closing is controlled by the control device 100. The gas back pressure regulation valve 27 in this embodiment is a proportional valve whose opening degree can be regulated. The gas back pressure regulation may be a motor valve or a proportional solenoid valve.

The gas back pressure regulation valve 27 is controlled based on a detection value detected by a pressure acquisition part 44. This embodiment has the pressure acquisition part 44 that acquires a pressure in the oxidant gas outlet pipe 42. The pressure acquisition part 44 detects a pressure of the oxidant gas flowing through the oxidant gas outlet pipe 42, and provides it to the control device 100. The control device 100 controls the gas back pressure regulation valve 27 based on pressure information provided by the pressure acquisition part 44. Namely, an opening degree of the gas back pressure regulation valve 27 is controlled based on a pressure of the oxidant gas acquired by the pressure acquisition part 44. Specifically, when a pressure acquired by the pressure acquisition part 44 increases, the gas back pressure regulation valve 27 is controlled such that its opening degree increases. When a pressure acquired by the pressure acquisition part 44 decreases, the gas back pressure regulation valve 27 is controlled such that its opening degree decreases.

In detail, the gas back pressure regulation valve 27 is controlled by a PWM (Pulse Width Modulation) converted drive pulse signal provided by the control device 100.

By way of example, when a pressure acquired by the pressure acquisition part 44 is a predetermined value desirable for operation, the gas back pressure regulation valve 27 is supplied with a drive pulse signal whose duty cycle is 50%, from the control device 100. When a pressure acquired by the pressure acquisition part 44 is more than the predetermined value desirable for operation, the gas back pressure regulation valve 27 is supplied with a drive pulse signal whose duty cycle is more than 50%, from the control device 100, and its opening degree increases. The more a difference between a pressure acquired by the pressure acquisition part 44 and the aforementioned predetermined value is, the more the duty cycle of the drive pulse signal becomes. On the other hand, when a pressure acquired by the pressure acquisition part 44 is less than the predetermined value desirable for operation, the gas back pressure regulation value 27 is supplied with a drive pulse signal whose duty cycle is less than 50%, from the control device 100, and its opening degree decreases.

Although the pressure acquisition part 44 acquires a pressure in the oxidant gas outlet pipe 42, a pressure detection position is not limited thereto. The pressure acquisition part 44 may detect a pressure of the oxidant gas in the fuel cell stack 10, or may detect a pressure of the oxidant gas in the storage part 20.

The circulating water pipe 50 has a supply pipe 51 and a return pipe 52 which are respectively connected to the fuel cell stack 10 and the storage part 20. The supply pipe 51 is connected to the storage part 20 such that an upstream end thereof is open to a liquid phase portion of the storage part 20. A downstream end of the supply pipe 51 is connected to the fuel cell stack 10. An upstream end of the return pipe 52 is connected to the fuel cell stack 10. Thus, the return pipe 52 receives a water component discharged from the fuel cell stack 20 and sends it to the storage part 20. The water component received by the return pipe 52 from the fuel cell stack 10 may contain circulating water for cooling and humidification, which has been previously stored in the storage part 20, and generated water generated in the fuel cell stack 10. The return pipe 52 is provided with a pump 53 for circulating the water component.

FIG. 2 schematically shows that the fuel gas inlet pipe 31 is connected to the upstream end of the fuel gas path 17, that the oxidant gas inlet pipe 41 is connected to the upstream end of the oxidant gas inlet path 18, and that the supply pipe 51 is connected to an upstream end of the circulating water path 19. Although not shown, the fuel gas outlet pipe 32 is connected to a downstream end of the fuel gas path 17, the oxidant gas outlet pipe 42 is connected to a downstream end of the oxidant gas path 18, and the return pipe 52 is connected to a downstream end of the circulating water path 19.

The control device 100 is electrically connected to the compressor 43, the drain valve 22, the gas back pressure regulation valve 27 and pressure acquisition part 44, and controls the compressor 43, the drain valve 22 and the gas back pressure regulation valve 27.

The control device 100 controls the compressor 43 based on a desired power generation output to control a supply amount of the oxidant gas from the compressor 43. This enables the control device 100 to control an operating pressure within the fuel cell stack 10 correspondingly to the power generation output. For example, when a desired power generation output is 10 kW, the control device 100 may set an operating pressure to 10 kPaG. For example, when a desired power generation output is 100 kW, the control device 100 may set an operating pressure to 150 kPaG.

In addition, the control device 100 controls the drain valve 22 and the gas back pressure regulation valve 27. The control device 100 generates a drive pulse signal which is PWM converted based on a pressure acquired by the pressure acquisition part 44, and provides it to the gas back pressure regulation valve 27. In this manner, the control device 100 controls an opening degree of the gas back pressure regulation valve 27. By way of example, when a pressure acquired by the pressure acquisition part 44 has a predetermined value desirable for operation, the control device 100 generates a drive pulse signal whose duty cycle is 50%. When a pressure acquired by the pressure acquisition part 44 has a value more than the predetermined value, the control device 100 generates a drive pulse signal whose duty cycle is more than 50%. When a pressure acquired by the pressure acquisition part 44 has a value less than the predetermined value, the control device 100 generates a drive pulse signal whose duty cycle is less than 50%. Thus, when a pressure acquired by the pressure acquisition part 44 increases, the gas back pressure regulation valve 27 is controlled such that its opening degree increases. On the other hand, when a pressure acquired by the pressure acquisition part 44 decreases, the gas back pressure regulation valve 27 is controlled such that its opening degree decrease.

In addition to the control of the gas back pressure regulation valve 27 based on a pressure of the oxidant gas acquired by the pressure acquisition part 44, the control device 100 also controls opening and closing of the drain valve 22 based on a pressure of the oxidant gas acquired by the pressure acquisition part 44. In detail, when a pressure of the oxidant gas acquired by the pressure acquisition part 44 becomes equal to or more than a first pressure threshold value, the control device 100 opens the drain valve 22. When a pressure of the oxidant gas acquired by the pressure acquisition part 44 becomes equal to or less than a second pressure threshold value after the control device 100 has opened the drain valve 22, the control device 100 closes the drain valve 22. Namely, when a pressure acquired by the pressure acquisition part 44 increases, the drain valve 22 is controlled to open. When a pressure acquired by the pressure acquisition part 44 decreases after the drain valve 22 has been opened, the drain valve 22 is controlled to close.

The first pressure threshold value is a value more than the second pressure threshold value. An appropriate value of the first pressure threshold value depends on an operating pressure. Thus, the control device 100 determines the first pressure threshold value based on an operating pressure set for the fuel cell stack 10. It is considered that, the more the set operating pressure is, the more the pressure variation is in response to a valve opening degree change and/or water level change. When a difference between the set operating pressure and the first pressure threshold value is small while the operating pressure is large, it may be difficult to appropriately detect an opening timing of the drain valve. In consideration of this point, the first pressure threshold value may be determined such that the more the set operating pressure is, the more the difference between the operating pressure and the first pressure threshold value is. For example, the first pressure threshold value may be determined to be an operating pressure+10% (i.e., operating pressure×1.10) over the entire operating pressure range. In this case, when an operating pressure is 10 kPaG, the first pressure threshold value is 11.0 kPaG. When an operating pressure is 150 kPaG, the first pressure threshold value is 165 kPaG.

Similarly, the control device 100 determines the second pressure threshold value based on an operating pressure set for the fuel cell stack 10. The second pressure threshold value may be determined such that the more the set operating pressure is, the more the difference between the operating pressure and the second pressure threshold value is. For example, the second pressure threshold value may be determined to be an operating pressure−5% (i.e., operating pressure×0.95) over the entire operating pressure range. In this case, when an operating pressure is 10 kPaG, the first pressure threshold value is 9.5 kPaG. When an operating pressure is 150 kPaG, the first pressure threshold value is 142.5 kPaG.

A difference between the operating pressure set for the fuel cell stack 10 and the second pressure threshold value may be less than a difference between the operating pressure and the first pressure threshold value. In this case, impairment of operation stability because of excessive pressure drop can be avoided by closing the drain valve 22 earlier. The second pressure threshold value may be the same as the operating pressure.

FIG. 3 is a view explaining a relationship between a pressure of the oxidant gas discharged from the fuel cell stack 10 and a timing of draining a water component in the storage part 20.

When the fuel cell system S1 starts power generation, the fuel cell stack 10 generates generated water. Some of the generated water condenses and flows into the circulating water path 19 through the separators (14, 15) to be stored in the storage part 20 from the return pipe 52. As a water level in the storage part 20 rises because of the increase in generated water, a gas path portion (gas phase portion) in the storage part 20 gradually narrows. As the gas path portion (gas phase portion) in the storage part 20 narrows, a pressure in the gas path portion in the storage part 20, a pressure in the oxidant gas outlet pipe 42, and a pressure in the fuel cell stack 1 increase.

When the pressures increase as above, the gas back pressure regulation valve 27 is controlled in a direction in which its opening degree increases. This optimizes a pressure of the oxidant gas. On the other hand, when the water level continues to rise, it becomes difficult to optimize a pressure of the oxidant gas by regulating the opening degree of the gas back pressure regulation valve 27. Then, as shown in an upper part of the graph in FIG. 3 showing a gas pressure, the pressure in the gas path portion in the storage part 20, the pressure in the oxidant gas outlet pipe 42, and the pressure in the fuel cell stack 1 increase. In this embodiment, when a pressure of the oxidant gas acquired by pressure acquisition part 44 becomes more than a first pressure threshold value pth1, the drain valve 22 is opened (“T1” in FIG. 3) as shown in a lower part of the graph in FIG. 3 showing an opening and closing state of the drain valve 22.

In the example of FIG. 3, when a pressure of the oxidant gas acquired by the pressure acquisition part 44 is continuously equal to or more than the first pressure threshold value Pth1 for a period of time Tc1, the drain valve 22 is opened. However, the drain valve 22 may be opened at a moment when a pressure of the oxidant gas acquired by the pressure acquisition part 44 becomes equal to or more than the first pressure threshold value Pth1.

As described above, since the drain valve 22 is opened, the water level in the storage part 20 lowers, and the pressure in the storage part 20 changes to a level equivalent to that of normal operation. When the water level lowers to reach a height of the intake port 21A of the drain pipe 21, discharge of the water component stops, and in this embodiment, the oxidant gas is discharged through the intake port 21A of the drain pipe 21. Then, a pressure in the storage part 20 decreases, so that a pressure acquired by the pressure acquisition part 44 decreases. At this time, the gas back pressure regulation valve 27 is controlled in a direction in which its opening degree is narrowed such that a pressure acquired by the pressure acquisition part 44 returns to the set operating pressure. Then, when a pressure of the oxidant gas acquired by the pressure acquisition part 44 becomes equal to or less than a second pressure threshold value Pth2, the control device 100 closes the drain valve 22 (“T2” in FIG. 3). Thereafter, the control returns to the pressure optimization control by means of the gas back pressure regulation valve 27. Then, the water level increases, the draining control starts.

In the example of FIG. 3, when a pressure of the oxidant gas acquired by the pressure acquisition part 44 is continuously equal to or less than the second pressure threshold value Pth2 for a period of time Tc2, the drain valve 22 is closed. However, the drain valve 22 may be closed at a moment when a pressure of the oxidant gas acquired by the pressure acquisition part 44 becomes equal to or less than the second pressure threshold value Pth2.

In this embodiment, since the intake port 21A is positioned above the bottom surface of the storage part 20, the draining operation is stopped when the water level lowers to the position of the intake port 21A. This avoids excessive discharge of the water component. While avoiding the excessive discharge of the water component, it is possible to appropriately detect a timing of closing the drain valve 22 (a timing at which a pressure in the storage part 20 sufficiently lowers) based on a pressure. However, even when the intake port 21A is connected to the bottom surface of the storage part 20, the same operation as described above can be performed.

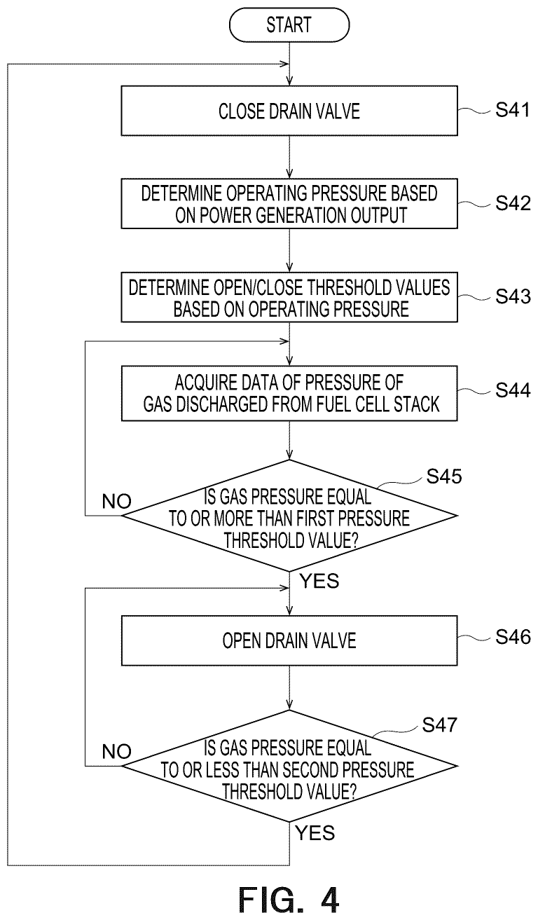

FIG. 4 is a flowchart explaining an operation of the fuel cell system S1 according to this embodiment, in detail, an example of a control operation of the drain valve 22 during operation.

The operation of FIG. 4 starts with an instruction of starting operation. At this time, the control device 100 first closes the drain valve 22 (step S41). Thereafter, the control device 100 determines an operating pressure based on a set power generation output (step S42). Then, the control device 100 determines a first pressure threshold value and a second pressure threshold value (opening and closing threshold values) based on the determined operating pressure (step S43). Thereafter, the control device 100 starts supplying the fuel gas, the oxidant gas, and the circulating water.

Then, the control device 100 acquires, from the pressure acquisition part 44, a pressure of the oxidant gas discharged from the fuel cell stack 10 (step S44). Then, the control device 100 determines whether the pressure of the oxidant gas acquired in step S44 is equal to or more than a first pressure threshold value (step S45).

When the pressure of the oxidant gas does not exceed the first pressure threshold value in step S45 (“NO” in step S45), the process returns to step S44 to continuously monitor the comparison between the pressure values. When the pressure of the oxidant gas is equal to or more than the first pressure threshold value in step S45 (“YES” in step S45), the control device 100 opens the drain valve 22 (step S46).

Thereafter, the control device 100 acquires, from the pressure acquisition part 44, the pressure of the oxidant gas discharged from the fuel gas cell stack 10, and determines whether the pressure is equal to or less than the second pressure threshold value (step S47). When the pressure of the oxidant gas is more than the second pressure threshold value in step S47 (“NO” in step S47), the process returns to step S46 to continuously monitor the comparison between the pressure values. When the pressure of the oxidant gas becomes equal to or less than the second pressure threshold value in step S47 (“YES” in step S47), the control device 100 returns the process to step S41 to close the drain valve 22 (step S46).

The above-described fuel cell system S1 according to the first embodiment controls the opening and closing of the drain valve 22 based on a pressure of the oxidant gas discharged from the fuel cell stack 10, which is acquired by the pressure acquisition part 44. In detail, when a pressure of the oxidant gas acquired by the pressure acquisition part 44 becomes equal to or more than the first pressure threshold value, the fuel cell system S1 opens the drain valve 22. Then, when a pressure of the oxidant gas acquired by the pressure acquisition part 44 becomes equal to or less than the second pressure threshold value after the fuel cell system S1 has opened the drain valve 22, the fuel cell system S1 closes the drain valve 22.

Since this structure opens and closes the drain valve 22 based on the detection of the pressure acquisition part 44, the structure for opening and closing the drain valve 22 and the process therefor can be prevented from being complicated. In addition, since the opening and closing of the drain valve 22 is determined based on a pressure value, error in determination of the opening and closing of the drain valve 22, which may be caused by inclination of the fuel cell system S1 and/or acceleration/deceleration can be reduced. Thus, the generated water increased in the fuel cell system can be appropriately discharged, without complicating the fuel cell system.

The first pressure threshold value is determined based on an operating pressure of the fuel cell stack 10. The second pressure threshold value is determined based on the operating pressure of the fuel cell stack 10. This allows the opening and closing threshold pressure values of the drain valve 22 to be appropriately determined, resulting in an appropriate draining operation based on the operating pressure.

An opening degree of the gas back pressure regulation valve 27 is controlled based on a pressure of the oxidant gas acquired by the pressure acquisition part 44. In this case, a sensor unit common to the drain valve 22 and the gas back pressure regulation valve 27, based on which they are operated, can be used. This can effectively reduce complexity in structure.

The drain pipe 21 is provided such that its intake port 21A is poisoned above the bottom surface of the storage part 20. This avoids excessive discharge of the water component during draining. Further, since the oxidant gas is allowed to flow into the intake port 21A, while avoiding the excessive discharge of the water component, it is possible to appropriately detect a timing of closing the drain valve 22 based on a pressure.

### Second Embodiment

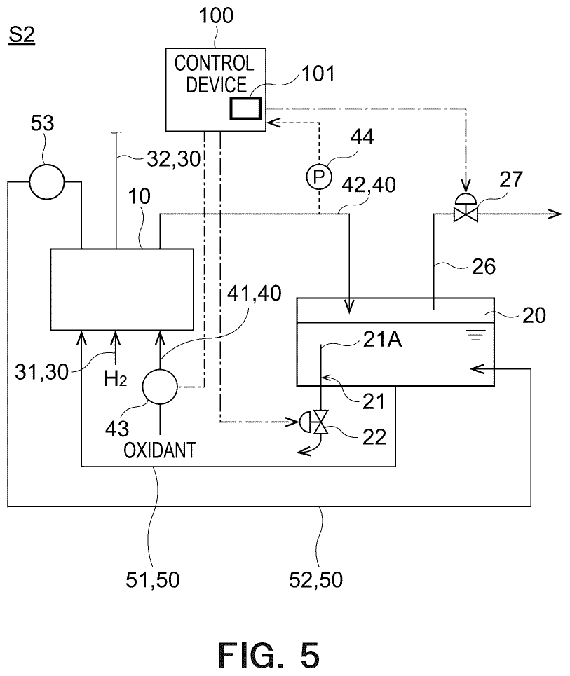

Next, a fuel cell system S2 according to a second embodiment is described with reference to FIGS. 5 to 7. The same reference numbers are used for the same parts as those in the first embodiment, and overlapping explanations are omitted.

As shown in FIG. 5, the fuel cell system S2 has a duty cycle acquisition part 101 that acquires a duty cycle of a drive pulse signal for the gas back pressure regulation valve 27. In this embodiment, the duty cycle acquisition part 101 constitutes a part of the control device 100. In order that the control device 100 generates a drive pulse signal with a predetermined duty cycle, the duty cycle acquisition part 101 acquires duty cycle information within the control device 100. Based on a duty cycle of the drive pulse signal acquired by the duty cycle acquisition part 101, the control device 100 controls the opening and closing of the drain valve 22.

In more detail, when a duty cycle of the drive pulse signal acquired by the duty cycle acquisition part 101 becomes equal to or more than a first duty threshold value, the control device 100 opens the drain valve 22. An amount of the generated water stored in the storage part 20 increases, a pressure in the fuel cell stack 10 increases. At this time, the control device 100 generates a drive pulse signal whose duty cycle is large such that an opening degree of the gas back pressure regulation valve 27 becomes large. Namely, in this embodiment, increase in pressure is detected based on generation of a drive pulse signal whose duty cycle is large, and a timing of draining is determined according to the increase in pressure. This optimizes a water level, and also optimizes a pressure (operating pressure) of the oxidant gas in the fuel cell stack 10.

When a duty cycle of the drive pulse signal acquired by the duty cycle acquisition part 101 becomes equal to or less than a second duty threshold value after the control device 100 has opened the drain valve 22, the control device 100 closes the drain valve 22.

The first duty threshold value is a value more than the second duty threshold value. An appropriate value of the first duty threshold value depends on an operating pressure. Thus, the control device 100 determines the first duty threshold value based on an operating pressure set for the fuel cell stack 10. It is considered that, the more the set operating pressure is, the more the pressure variation is in response to a valve opening degree change and/or water level change. When the set operating pressure is large and the first duty threshold value is a large value, there is a possibility that a timing of opening and closing the drain valve is undesirably delayed. In consideration of this point, the first duty threshold value may be determined such that the more the set operating pressure is, the less the first duty threshold value is. For example, when the first duty threshold value is set to be 90% for an operating pressure of 10 kPaG, the first duty threshold value may be set to be 80% for an operating pressure of 150 kPaG.

Similarly, the control device 100 determines the second duty threshold value based on an operating pressure set for the fuel cell stack 10. The second duty threshold value may be determined such that the more the set operating pressure is, the more the second duty threshold value is. For example, when the second duty threshold value set to be 45% for an operating pressure of 10 kPaG, the second duty threshold value may be set to be 48% for an operating pressure of 150 kPaG.

A difference between a duty cycle (50%) of a drive pulse signal for maintaining an opening degree of the gas back regulation valve 27 and the second duty threshold value may be less than a difference between the 50% duty cycle and the first duty threshold value. In this case, impairment of operation stability because of excessive pressure drop can be avoided by closing the drain valve 22 earlier. The second pressure threshold value may be 50%.

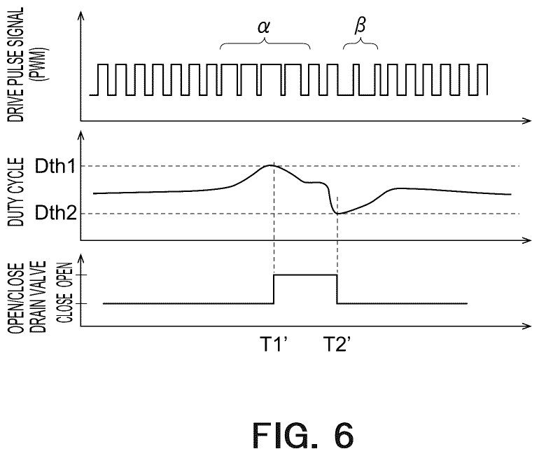

FIG. 6 is a view explaining a relationship between a duty cycle of a drive pulse signal for the gas back pressure regulation valve 27 and a timing of draining a water component stored in the storage part 20. Namely, FIG. 6 is a view explaining the control of the drain valve 22 by the control device 100.

As a water level in the storage part 20 rises because of the increase in generated water generated in the fuel cell stack 10, a gas path portion (gas phase portion) in the storage part 20 gradually narrows. As the gas path portion (gas phase portion) in the storage part 20 narrows, a pressure in the gas path portion in the storage part 20, a pressure in the oxidant gas outlet pipe 42, and a pressure in the fuel cell stack 10 increase.

When the pressures increase as above, the gas back pressure regulation valve 27 is controlled in a direction in which its opening degree increases. This optimizes a pressure of the oxidant gas. On the other hand, when the water level continues to rise, it becomes difficult to optimize the pressure of the oxidant gas by regulating the opening degree of the gas back pressure regulation valve 27. Then, as shown in a range a of a drive pulse signal state in an upper part of FIG. 6, the duty cycle of the drive pulse signal for the gas back pressure regulation valve 27 continues to be significantly larger than normal (50%). A vertically middle part of the graph in FIG. 6 shows a duty cycle value. As shown in a lower part of FIG. 6 showing the opening and closing state of the drain valve 22, when a duty cycle of the drive pulse signal acquired by the duty cycle acquisition part 101 becomes more than the first duty threshold value Dth1, the drain valve 22 is opened (“T1” in FIG. 6).

In the example of FIG. 6, when the duty cycle of the drive pulse signal acquired by the duty cycle acquisition part 101 is continuously more than the first duty threshold value Dth1 for a predetermined period of time, the drain valve 22 is opened. However, the drain valve 22 may be opened at a moment when the duty cycle of the drive pulse signal acquired by the duty cycle acquisition part 101 becomes equal to or more than the first duty threshold value Dth1.

As described above, since the drain valve 22 is opened, the water level in the storage part 20 lowers, and the pressure in the storage part 20 changes to a level equivalent to that of normal operation. When the water level lowers to reach a height of the intake port 21A of the drain pipe 21, discharge of the water component stops, and in this embodiment, the oxidant gas is discharged through the intake port 21A of the drain pipe 21. Then, the pressure in the storage part 20 decreases, so that the pressure acquired by the pressure acquisition part 44 decreases. Thus, as shown in a range p of the drive pulse signal state in the upper part of FIG. 6, the gas back pressure regulation valve 27 is supplied with a drive pulse signal whose duty cycle is small, so as to be controlled in a direction in which its opening degree is narrowed such that the pressure acquired by the pressure acquisition part 44 returns to the set operating pressure. Then, when a duty cycle of the drive pulse signal acquired by the duty cycle acquisition part 101 becomes equal to or less than the second duty threshold value Dth2, the control device 100 closes the drain valve 22 (“T2” in FIG. 3). Thereafter, the control returns to the pressure optimization control by means of the gas back pressure regulation valve 27. Then, the water level increases, the draining control starts.

In the example of FIG. 6, when the duty cycle of the drive pulse signal acquired by the duty cycle acquisition part 101 is continuously equal to or less than the second duty threshold value Dth2 for a predetermined period of time, the drain valve 22 is closed. However, the drain valve 22 may be closed at a moment when the duty cycle of the drive pulse signal acquired by the duty cycle acquisition part 101 becomes equal to or less than the second duty threshold value Dth2.

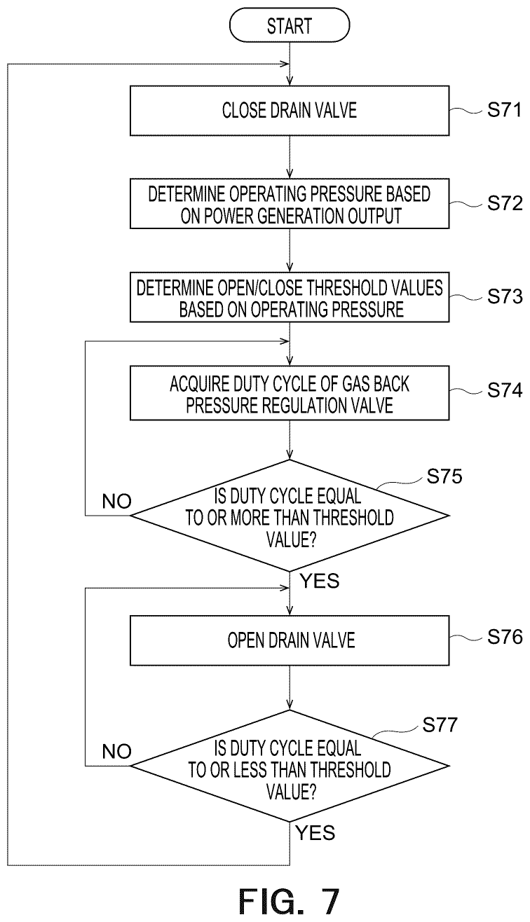

FIG. 7 is a flowchart explaining an operation of the fuel cell system S2 according to the second embodiment, in detail, an example of a control operation of the drain valve 22.

The operation of FIG. 7 starts with an instruction of starting operation. At this time, the control device 100 first closes the drain valve 22 (step S71). Thereafter, the control device 100 determines an operating pressure based on a set power generation output (step S72). Then, the control device 100 determines a first duty threshold value and a second duty threshold value based on the determined operating pressure (step S73). Thereafter, the control device 100 starts supplying the fuel gas, the oxidant gas, and the circulating water.

Then, the control device 100 acquires, from the duty cycle acquisition part 101, a duty cycle of a drive pulse signal for the gas back pressure regulation valve 27 (step S74). Then, the control device 100 determines whether the duty cycle of the drive pulse signal acquired in step S74 is equal to or more than the first duty threshold value (step S75).

When the duty cycle does not exceed the first duty threshold value in step S75 (“NO” in step S75), the process returns to step S74 to continuously monitor the comparison between the duty cycle values. When the duty cycle is equal to or more than the first duty threshold value in step S75 (“YES” in step S75), the control device 100 opens the drain valve 22 (step S76).

Thereafter, the control device 100, from the duty cycle acquisition part 101, the duty cycle of the drive pulse signal, and determines whether the duty cycle is equal to or less than the second duty threshold value (step S77). When the duty cycle is more than the second duty threshold value in step S77 (“NO” in step S77), the process returns to the step S76 to continuously monitor the comparison between the duty cycle values. When the duty cycle becomes equal to or less than the second duty threshold value in step S77 (“YES” in step S77), the control device 100 returns the process to the step S71 to close the drain valve 22 (step S71).

The above-described fuel cell system S2 according to the second embodiment controls the opening and closing of the drain valve 22 based on a duty cycle of a drive pulse signal for the gas back pressure regulation valve 27, which is acquired by the duty cycle acquisition part 101. In detail, when the duty cycle of the drive pulse signal becomes equal to or more than the first duty threshold value, the fuel cell system S2 opens the drain valve 22. Then, when a duty cycle of the drive pulse signal becomes equal to or less than the second duty threshold value after the fuel cell system S2 has opened the drain valve 22, the fuel cell system S2 closes the drain valve 22.

Since this structure opens and closes the drain valve 22 based on a drive pulse signal generated for controlling the gas back pressure regulation valve 27, the structure for opening and closing the drain valve 22 and the process therefore can be prevented from being complicated. In addition, since the opening and closing of the drain valve 22 is determined based on a control signal for the gas back pressure regulation valve 27, error in determination of the opening and closing of the drain valve 22, which may be caused by inclination of the fuel cell system S2 and/or acceleration/deceleration can be reduced. Thus, the generated water increased in the fuel cell system can be appropriately discharged, without complicating the fuel cell system.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the sprit of the inventions. The accompanying claims and their equivalents are intended to cover such forms or modifications as would fail within the scope and spirit of the invention.

1. A fuel cell system comprising:
a fuel cell stack;
a storage part that stores a water component including circulating water supplied to the fuel cell stack and circulated from the fuel cell stack, and generated water generated in the fuel cell stack and discharged from the fuel cell stack;
a gas outlet pipe that sends a gas discharged from the fuel cell stack to the storage part;
a pressure acquisition part that acquires a pressure of the gas discharged from the fuel cell stack;
a drain pipe connected to the storage part to allow the water component discharged from the storage part to flow therethrough;
a drain valve on the drain pipe; and
a control device that controls opening and closing of the drain valve;
wherein the control device controls the opening and closing of the drain valve based on a pressure of the gas acquired by the pressure acquisition part.

2. The fuel cell system according to claim 1, wherein
when a pressure of the gas acquired by the pressure acquisition part becomes equal to or more than a first pressure threshold value, the control device opens the drain valve.

3. The fuel cell system according to claim 2, wherein
the control device determines the first pressure threshold value based on an operating pressure of the fuel cell stack.

4. The fuel cell system according to claim 1, wherein
when a pressure of the gas acquired by the pressure acquisition part becomes equal to or less than a second pressure threshold value after the control device has opened the drain valve, the control device closes the drain valve.

5. The fuel cell system according to claim 4, wherein
the control device determines the second pressure threshold value based on an operating pressure of the fuel cell stack.

6. A fuel cell system comprising:
a fuel cell stack;
a storage part that stores a water component including circulating water supplied to the fuel cell stack and circulated from the fuel cell stack, and generated water generated in the fuel cell stack and discharged from the fuel cell stack;
a gas outlet pipe that sends a gas discharged from the fuel cell stack to the storage part;
a pressure acquisition part that acquires a pressure of the gas discharged from the fuel cell stack;
a gas back pressure regulation valve that regulates a pressure of the gas to be sent to the storage part, based on a drive pulse signal whose duty cycle is varied based on a pressure of the gas acquired by the pressure acquisition part;
a duty cycle acquisition part that acquires a duty cycle of the drive pulse signal for the gas back pressure regulation valve;
a drain pipe connected to the storage part to allow the water component discharged from the storage part to flow therethrough;
a drain valve on the drain pipe; and
a control device that controls opening and closing of the drain valve;
wherein the control device controls the opening and closing of the drain valve based on a duty cycle of the drive pulse signal acquired by the duty cycle acquisition part.

7. The fuel cell system according to claim 6, wherein
when a duty cycle of the drive pulse signal acquired by the duty cycle acquisition part becomes equal to or more than a first duty threshold value, the control device opens the drain valve.

8. The fuel cell system according to claim 7, wherein
the control device determines the first duty threshold value based on an operating pressure of the fuel cell stack.

9. The fuel cell system according to claim 6, wherein
when a duty cycle of the drive pulse signal acquired by the duty cycle acquisition part becomes equal to or less than a second duty threshold value after the control device has opened the drain valve, the control device closes the drain valve.

10. The fuel cell system according to claim 9, wherein
the control device determines the second duty threshold value based on an operating pressure of the fuel cell stack.

11. The fuel cell system according to claim 1, further comprising a gas back pressure regulation valve that regulates a pressure of the gas discharged from the fuel cell stack,
wherein an opening degree of the gas back pressure regulation valve is controlled based on a pressure of the gas acquired by the pressure acquisition part.

12. The fuel cell system according to claim 1, wherein
the drain pipe is disposed such that its intake port is positioned above a bottom surface of the storage part.

13. The fuel cell system according to claim 6, wherein
the drain pipe is disposed such that its intake port is positioned above a bottom surface of the storage part.

14. A control method of a fuel cell system including: a fuel cell stack; a storage part that stores a water component including circulating water supplied to the fuel cell stack and circulated from the fuel cell stack, and generated water generated in the fuel cell stack and discharged from the fuel cell stack; a gas outlet pipe that sends a gas discharged from the fuel cell stack to the storage part; a drain pipe connected to the storage part to allow the water component discharged from the storage part to flow therethrough; and a drain valve on the drain pipe; the control method comprising:
acquiring a pressure of the gas discharged from the fuel cell stack; and
controlling opening and closing of the drain valve based on an acquired pressure of the gas.
